(19) United States
(12) Patent Application Publication
(10) Pub. No.: US 2006/0168292 A1
(43) Pub. Date: Jul. 27, 2006

(54) Apparatus and method for receiving or transmitting contents

(76) Inventor: Takanori Yukimatsu, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/213,774

(22) Filed: Aug. 30, 2005

(30) Foreign Application Priority Data
Nov. 22, 2004 (JP) JP2004-336859

(51) Int. Cl. G06F 15/16

(52) U.S. Cl. 709/231; 709/230

(57) ABSTRACT

A solution is provided for a problem that image playback processing is temporarily stopped due to content data transmitted from a content transmitter which has not arrived at a content receiver when contents are transmitted using a wired or a wireless LAN. When content data transmitted from the content transmitter does not arrive at the content receiver, the content receiver transmits a particular pseudo content reception confirmation response to the content transmitter to request the same to transmit the next content data.

### INCORPORATION BY REFERENCE

The present application claims priority from Japanese application JP2004-336859 filed on Nov. 22, 2004, the content of which is hereby incorporated by reference into this application.

### BACKGROUND OF THE INVENTION

The present invention relates to transmission/reception of contents such as video and audio through a network, and more particularly, to transmission/reception of stream images.

In step of the advance in processing capabilities of personal computers (hereinafter called the “PC”) such as the processing speed, storage capacity and the like, increasingly larger capacities of hard disk drives (hereinafter called the “HDD”) have been built in PC's. Under such situations, even PC's of a rank intended for general family use can be recently used to record TV broadcast programs in HDD's built therein and display the recorded programs on a display for viewing.

On the other hand, lower prices of large capacity HDD's have permitted family-use recording apparatuses to contain HDD's for digitally recording video and audio information. Such HDD recording apparatuses draw attention because of their user-friendliness resulting from the use of the HDD as a recording medium. Also, in parallel with the increase in processing speed and capacity of PC's, the Internet has become widespread, and high-speed network systems have been introduced using optical fibers and the like. With the evolution of the PC's and network systems, not only digital data used by PC's but also video signals, audio signals and the like can be digitized to transmit high-quality video and audio signals in real time.

In such situations, Toshiba Review, Vol. 57, No. 9 (Non-patent Document 1) describes an example of a recording apparatus which is equipped with a wired or a wireless LAN (Local Area Network) interface such that video and audio signals recorded thereby can be transmitted to another PC or receiver through a network for reproduction of the signals anywhere in the premises.

However, when the wired or wireless LAN is used to transmit data which requires the real-time nature, congestion on the network can cause a loss of data stored in IP (Internet Protocol) packets in course of transmission to damage the real-time nature of the data. To solve this problem, JP-A-10-313350 (Patent Document 1), for example, discloses a network system in which even if errors occur in requested data in course of transmission of the data, data including the errors is retransmitted after all the requested data has been transmitted to avoid disturbance on the network due to the retransmission of the data and enable continuous communications without damaging the real-time nature.

Also, JP-A-2003-169040 (Patent Document 2), for example, discloses a data communications system which efficiently utilizes a retransmission request with the aid of an ARQ (Automatic Repeat reQuest) function, wherein a data receiver terminal gives up a request for a retransmission, when data is too late for reproduction, in consideration of a playback processing time and a round trip time (RTT), thereby enabling the reproduction of high-quality data.

### SUMMARY OF THE INVENTION

In the transmission/reception of stream images and/or live images through the wired or wireless LAN, if the video/audio data fails to arrive at the receiver due to a transmission delay of the video/audio data, missing of the video/audio data halfway on a path, and the like when a transmission control protocol (hereinafter called the “TCP”) connection is made between a transmitter and a receiver to transmit/receive stream images stored in a video/audio storing means or live video signals delivered from the ground-based facilities or from satellites, particularly, when stream images and/or live images are transmitted/received through the wireless LAN, the video/audio data is retransmitted at the TCP. The receiver cannot reproduce video or audio until the video/audio data arrives at the receiver, giving rise to a problem of interrupted image reproduction.

For example, when video/audio data is transmitted/received through a home network, data is transmitted through the TCP connection in order to guarantee the quality of the video/audio data transmitted to a receiver. Particularly, in the transmission/reception of contents which employs the DTCP (Digital Transmission Content Protection) system that takes into consideration the copy right protection of contents, it is defined to make the TCP connection between a transmitter and a receiver, and perform an HTTP (Hyper Text Transfer Protocol) based data transfer. Even in this event, if encrypted data does not arrive at a receiver, the receiver cannot decrypt the data for reproduction, giving rise to a problem of interrupted image reproduction similar to the above.

To solve the foregoing problems, the present invention provides a content receiver which includes a network communication processing module for transmitting/receiving data through a network, a content reception processing module for receiving content data received from a content transmitter connected through the network from the network communications processing module, a video/audio data storage module for storing video/audio data, and a processing control module for controlling the operation of the network communication processing module, the content reception processing module, and the video/audio data storage module, wherein the content receiver makes a transmission control protocol connection with the content transmitter, and the content receiver transmits a particular content data reception confirmation response to the content transmitter, when the content receiver confirms that part of content data delivered from the content transmitter has not arrived at the content receiver, without transmitting a content data nonarrival response to request a retransmission of the content data.

Another content receiver of the present invention includes the modules set forth above, wherein the content receiver makes a transmission control protocol connection with the content transmitter, and the content receiver transmits a content data nonarrival response in the transmission control protocol connection when the content receiver confirms that part of content data delivered from the content transmitter has not arrived at the content receiver, and transmits a particular content data reception conformation response to the content transmitter when the content data has not arrived for a predefined time.

Thus, the present invention can provide a transmitter and a receiver which solve the problem that image playback processing is temporarily stopped due to content data which has not arrived at the content receiver, during a TCP-based transmission of content data through a wired or a wireless LAN, and allow the user to view stream images and live images without interruption.

Accordingly, the present invention can accomplish a transmitter and a receiver which allow the user to view stream images and live images without interruption.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating the configuration of a content transmitter and a content receiver according to a first embodiment of the present invention;

FIG. 2 is a block diagram illustrating an exemplary configuration of a domestic LAN in one embodiment of the present invention;

FIG. 3 is a diagram illustrating a normal procedure for transmitting contents from the content transmitter to the content receiver;

FIG. 4 is a diagram illustrating a procedure for transmitting contents according to the first embodiment of the present invention;

FIG. 5 is a diagram illustrating a procedure for transmitting contents according to a second embodiment of the present invention;

FIG. 6 is a block diagram illustrating the configuration of a content transmitter and a content receiver according to a third embodiment of the present invention;

FIG. 7 is a diagram illustrating a procedure for transmitting contents according to the third embodiment of the present invention;

FIG. 8 is a block diagram illustrating the configuration of a content transmitter and a content receiver using a wireless LAN according to a fourth embodiment of the present invention; and

FIG. 9 is a block diagram illustrating the configuration of a domestic wireless LAN according to the fourth embodiment of the present invention.

### DESCRIPTION OF THE EMBODIMENTS

In the following, some embodiments of the present invention will be described with reference to the accompanying drawings.

### First Embodiment

The following description will be given of a first embodiment of the present invention.

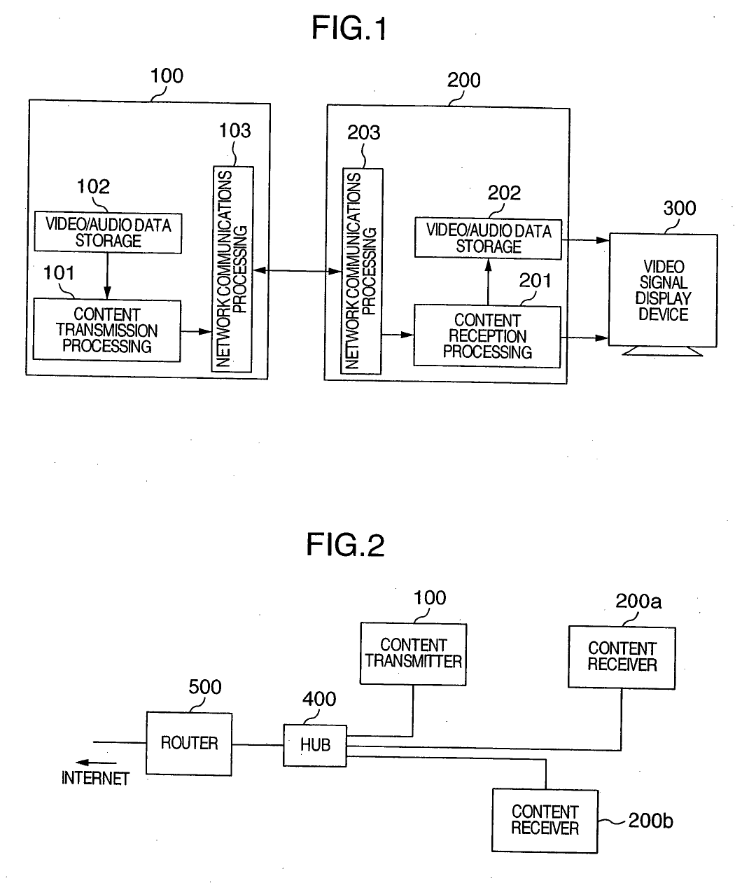

FIG. 1 illustrates the configuration of a content transmitter 100 and a content receiver 200 according to the first embodiment of the present invention, where the content transmitter 100 and content receiver 200 are interconnected through a LAN. The content transmitter 100 comprises a content transmission processing circuit 101 for sending contents to the content receiver 200; a video/audio storage circuit 102 for storing video/audio data, for example, video/audio data delivered from satellites or ground-based facilities; and a network communications processing circuit 103 for communicating content data, inputted to or outputted from the content transmission processing circuit 101, with other apparatuses through the LAN.

The content receiver 200 comprises a content reception processing circuit 201 for receiving content data sent thereto through the LAN; a video/audio data storage circuit 202 for storing content data sent thereto through the LAN; a network communications processing circuit 203 for communicating content data with other apparatuses through the LAN; and a video signal display device 300 for displaying a video signal outputted from the content receiver 200, for example, a television monitor such as a liquid crystal display television, a plasma display and the like, or a computer display.

Alternatively, the functions of content receiver 200 may be incorporated in the video signal display device 300 so that the resulting video signal display device can directly transmit and receive content data to and from the content transmitter 100.

In FIG. 1, the content transmission processing circuit 101 retrieves content data to be transmitted to the content receiver 200 from the video/audio storage circuit 102, and network communications processing circuit 103 transmits the content data to other devices connected thereto through a network. In the content receiver 200, the content data can be received by the content reception processing circuit 201 through the network communications processing circuit 203 for storage in the video/audio data storage circuit 202 or for display on the video signal display device 300.

FIG. 2 illustrates an exemplary configuration of a domestic LAN which includes the content transmitter 100 and content receiver 200. One content transmitter 100 and two content receivers 200a, 200b are connected to a network hub device 400 through cables of the wired LAN, respectively, while the network hub device 400 is connected to a router 500. The router 500 is connected to the Internet through a modem, an electro-optical converter or the like. The content transmitter 100, content receivers 200a, 200b, and router 500 have their respective IP addresses for identifying themselves on the LAN.

Each of the network communications processing circuits 103, 203 comprises an interface which has been previously assigned a 48-bit MAC (Media Access Network) address during the manufacturing. The IP addresses may be set to the respective devices in accordance with DHCP (Dynamic Host Configuration Protocol) which has been conventionally employed widely in address automatic setting, for example, with the router 400 forced to function as a DHCP server from which the IP addresses may be assigned to the respective devices.

When IPv6 (Internet Protocol version 6) is used, each device can determine its own IP address from the upper 64 bits of the IP address of the router 500 and the MAC address by a method called “stateless automatic setting”.

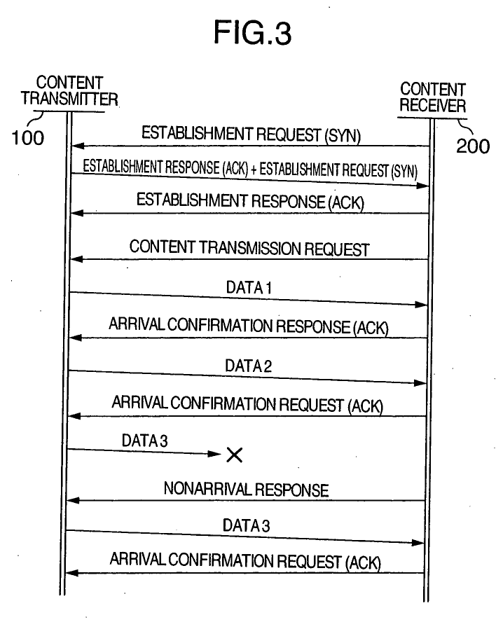

FIG. 3 illustrates an exemplary procedure for normal transmission/reception of contents between the content transmitter 100 and content receiver 200.

The left side of the figure represents the content transmitter 100, while the right side of the figure represents the content receiver 200, wherein timings and directions of transmission/reception of data between the two parties are indicated by arrows. A connection is established using TCP three-way hand-shake which establishes a connection through an exchange of an establishment request (SYN) and an establishment response (ACK). Contents are transmitted/received after a connection has been established between the content transmitter 100 and content receiver 200.

First, a connection is established between the content transmitter 100 and content receiver 200. After the establishment of the connection between the content transmitter 100 and content receiver 200, the content receiver 200 transmits a content transmission request to the content transmitter 100. The content transmitter 100 transmits requested content to the content receiver 200. For example, if content data 3 transmitted from the content transmitter 100 fails to arrive at the content receiver 200 due to missing on a path, through which the content data 3 is transferred, or congestion on the path, a content nonarrival response is transmitted to the content transmitter 100 on a TCP layer of the content receiver 200 to request a retransmission of the content data 3 which has not arrived. After receiving the content nonarrival response, the content transmitter 100 retransmits the content data 3 to the content receiver 200.

In this event, the content transmitter 100 attempts to retransmit the content data 3 to the content receiver 200 by a function of a TCP layer until the content data 3 arrives at the content receiver 200 with certainty, whereas the content receiver 200 cannot perform playback processing of the contents until the content data 3 arrives, giving rise to a problem of interrupted image playback.

As an exemplary approach for solving the foregoing problem, in the first embodiment, when content data does not arrive from the content transmitter 100, the content receiver 200 virtually transmits a particular content reception response to the content transmitter 100 to request the transmission of next content data, thereby avoiding a retransmission of the content data 3 on the TCP layer in response to the content nonarrival response, and the content data 3 which has not arrived is discarded to solve the problem of the interrupted image reproduction in the content receiver 200.

In the following, the first embodiment will be described in greater detail.

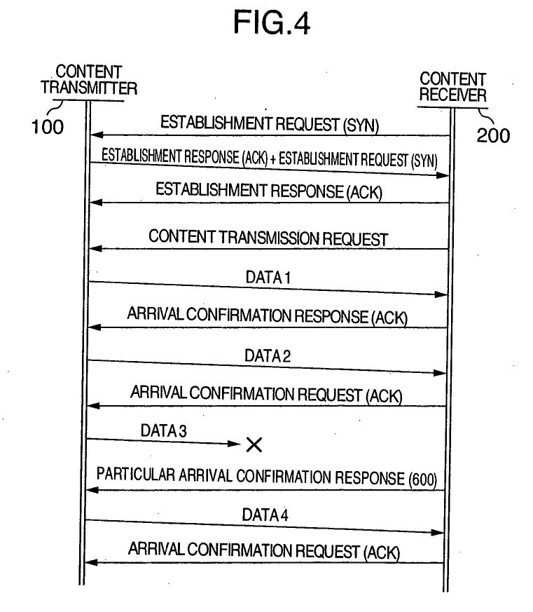

FIG. 4 illustrates an exemplary procedure for content transmission/reception performed between the content transmitter 100 and content receiver 200 in the first embodiment of the present invention.

A connection between the content transmitter 100 and content receiver 200 is established using the three-way hand-shake of TCP, and the procedure for the transmission/reception of data on the way is the same as that for normal transmission/reception described with reference to FIG. 3.

During transmission/reception of content data between the content transmitter 100 and content receiver 200, if the content data 3 does not arrive at the content receiver 300 due to missing of the content data 3 on a path through which it is transferred or due to congestion on the path, the content receiver 200 does not transmit the content data nonarrival response, which is a TCP layer function, but transmits a particular content arrival confirmation response 600, which virtually indicates that the content data 3 has arrived, to the content transmitter 100.

The particular content arrival confirmation response 600 is transmitted to the content transmitter 100 with a higher priority than the content data nonarrival response. The particular content arrival confirmation response 600 is used in a manner similar to the arrival confirmation response (ACK) used in the TCP layer function, and instructs the content transmitter 100 not to retransmit the content data 3.

Upon receipt of the particular content arrival confirmation response 600, the content transmitter 100 determines that the content data 3 has arrived at the content receiver 200, and transmits the next content data 4 to the content receiver 200.

This can avoid a retransmission of the content data 3, which is a TCP layer function, when the content data fails to arrive at the content receiver 200, and can solve the problem of the interrupted image playback in the content receiver 200 due to the retransmission of the missing content data.

Also, the particular content arrival confirmation response 600 is not particularly limited as long as the content transmitter 100 can understand that the content data 3 has not arrived at the content receiver 200 and that the content receiver 200 virtually transmits a response indicative of the arrival of the content data 3.

Further, upon receipt of the content arrival confirmation response 600, the content transmitter 100 may store the content data 3 which does not arrive at the content receiver 200, such that the content data 3 can be transmitted when the bandwidth is reserved for content transmission so that the content data 3 can be securely transmitted to the content receiver 200, for example, in a situation where the content data 3 must be transmitted to the content receiver 200 without fail for a copy or a move of the contents. In this way, a video/audio signal, representative of a live stream or the like, can playback without interruption of images when it is being transmitted, and high-quality data can also be transferred such as a copy of the contents.

### Second Embodiment

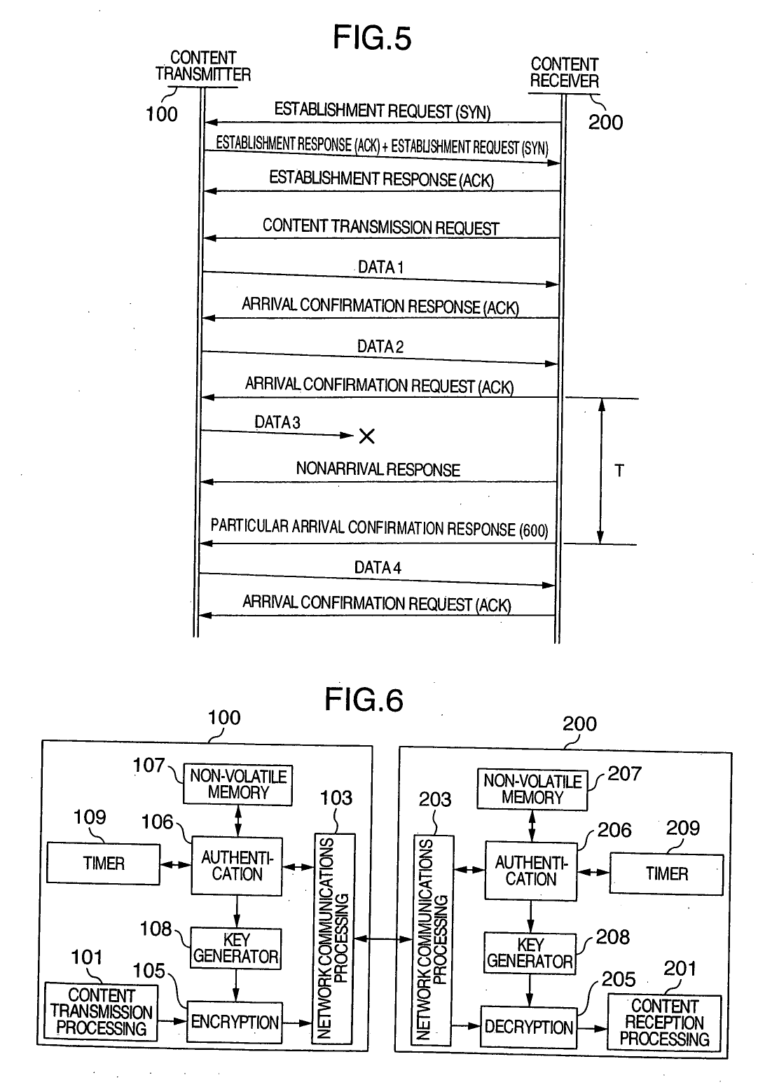

Next, a second embodiment of the present invention will be described with reference to FIG. 5.

FIG. 5 illustrates an exemplary procedure for transmission/reception of contents performed between the content transmitter 100 and content receiver 200 in the second embodiment of the present invention.

The configuration of the content transmitter 100 and content receiver 200 is the same as that illustrated in FIG. 1. A connection between the content transmitter 100 and content receiver 200 is established using the three-way hand-shake of TCP, and the processing of content data in the middle of the transmission/reception is the same as that for the normal transmission/reception described in connection with FIG. 3.

During transmission/reception of content data between the content transmitter 100 and content receiver 200, if the content data 3 does not arrive at the content receiver 200 due to missing on a path through which the content data 3 is transferred, or due to congestion on the path, the content receiver 200 first transmits a content nonarrival response using the TCP layer function to request the content transmitter 100 for a retransmission of the content data 3.

In response, the content transmitter 100 retransmits the content data 3 using the TCP function. However, if the content receiver 200 cannot receive the content data 3, for example, even after the content receiver 200 has waited for a time (T) until immediately before the end of a reproduced image from content data 2 previously received from the content transmitter 100, the content receiver 200 transmits the particular content arrival confirmation response 600 to the content transmitter 100 as does in the first embodiment.

This particular content arrival confirmation response 600 aborts the retransmission of the content data 3, which has not been received, by the TCP layer function and permits the content receiver 200 to request the content transmitter 100 to transmit the next content data 4, thus making it possible to solve the problem of interrupted images due to the content data 3 which fails to arrive at the content receiver 200.

### Third Embodiment

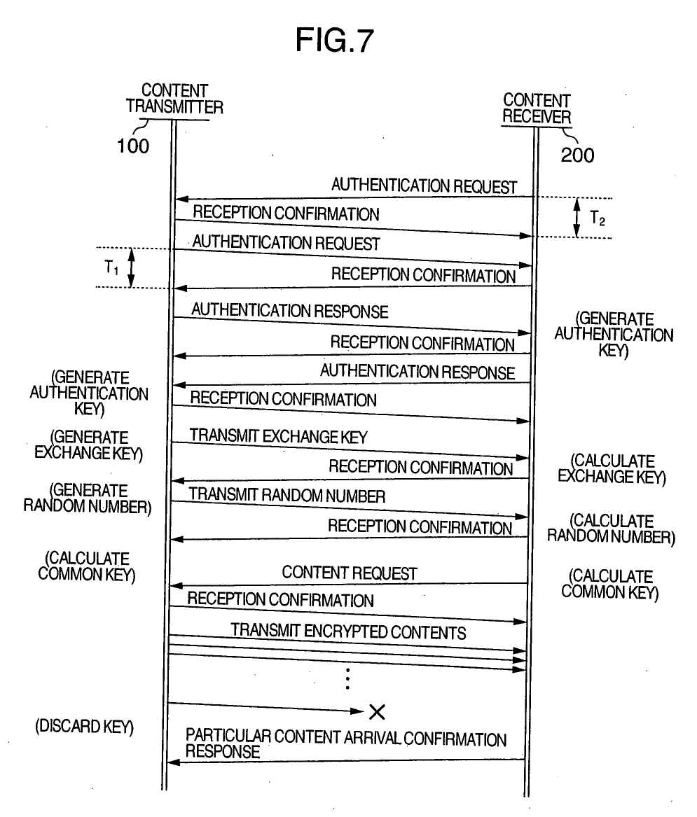

Next, a third embodiment of the present invention will be described with reference to FIGS. 6 and 7.

FIG. 6 illustrates the configuration of the content transmitter 100 and content receiver 200 in the third embodiment of the present invention, where the content transmitter 100 and content receiver 200 are interconnected through a LAN. The content transmitter 100 comprises an encryption circuit 105 for encrypting contents delivered from the content transmission processing circuit 101; an authentication circuit 106 for communicating information with another device connected on the LAN to perform mutual authentication between this device and content transmitter 100; a non-volatile memory 107 for storing information required for the processing in the authentication circuit 106; a key generator circuit 108 for generating key information required to encrypt contents in the encryption circuit 105 based on information of the authentication circuit 106; and a timer circuit 109 for measuring a time from the transmission of information such as an authentication request generated by the authentication circuit 106 to another device to the arrival of a reception confirmation to the information. Contents transmitted from the content transmission processing circuit 101 are appended with one of identification codes “copy free”, “copy one generation”, “no more copies”, and “copy never” indicative of how to handle the content, before they are transmitted to the content receiver 200.

The content receiver 200 comprises a decryption circuit 205 for receiving contents encrypted by the encryption circuit 105 of the content transmitter 100 from the network communications processing circuit 203, decrypting the contents and outputting the decrypted contents to the content reception processing circuit 201; an authentication circuit 206 for communicating information with another device to perform mutual authentication between this device and the content receiver 200; a non-volatile memory 207 for storing information required for the processing in the authentication circuit 206; a key generator circuit 208 for generating a key required to decrypt contents in the decryption circuit 206 based on the information outputted by the authentication circuit 206; and a timer circuit 209 for measuring a time from the transmission of information such as an authentication request to another device from the authentication circuit 206 to the arrival of a reception confirmation for the information. Received contents are processed in accordance with one of the identification codes “copy free”, “copy one generation”, “no more copies”, and “copy never” which is transmitted together with the contents. Contents specified as “copy free” and “copy one generation” can be recorded on a recording medium, and when one wishes to record contents specified as “copy one generation”, the contents are subsequently handled as “copy one generation”. As noted, the video/audio storage circuits 102, 202 and video signal display device 300 are omitted in FIG. 6.

In this embodiment, upon transmission of contents through a wired or a wireless LAN, the contents can undergo copy protection for preventing illegal duplications of the contents. In addition, the content transmitter 100 and content receiver 200 can solve the problem that a reproduced image is interrupted due to a loss of content data during the transmission, and a delay of content data.

FIG. 7 illustrates an exemplary procedure for content transmission/reception between the content transmitter 100 and content receiver 200. The left side of the figure represents the content transmitter 100, while the right side of the figure represents the content receiver 200, wherein timings and directions of transmission/reception of data between the two parties are indicated by arrows.

First, the content receiver 200 creates an authentication request. A public key unique to the content receiver 200, and a certificate for the public key are added to the authentication request which is then sent to the content transmitter 100. As the content transmitter 100 has received the authentication request and sent a reception confirmation therefor to the content receiver 200, the content transmitter 100 creates an authentication request from its own side, and transmits the authentication request to the content receiver 200 together with a public key unique to the content transmitter 100, published by an authentication authority, and a certificate therefor. Then, the timer circuit 109 is started to measure a time T1 until a reception confirmation for the authentication request from the content receiver 200 by the content transmitter 100.

When the value measured by the timer circuit 109 does not exceed a predetermined value (T), i.e., when T1<T, the content transmitter 100 authenticates that the content receiver 200 is located within a personal use range (hereinafter called the “time authentication”).

In this event, the timer 209 may be started when the content receiver 200 transmits the authentication request to the content transmitter 100 to measure a time T2 until a reception confirmation from the content transmitter 100 is received by the content receiver 200 to accomplish the time authentication.

When the authentication is successful on both parties, a common authentication key is generated and shared by the content transmitter 100 and content receiver 200. Upon completion of the sharing of the authentication key, the content transmitter 100 generates an exchange key and a random number which are respectively encrypted by the authentication key, and sent to the content receiver 200.

In FIG. 7, the exchange key and random number are separately transmitted from the content transmitter 100 to the content receiver 200, but they may be sent together.

The content receiver 200 decrypts the exchange key transmitted from the content transmitter 100 using the authentication key, and holds the decrypted exchange key together with the random number which has been received and decrypted in a similar manner. Subsequently, each of the content transmitter 100 and content receiver 200 generates a common key using the exchange key and random number in accordance with a predefined calculation algorithm.

With the common key thus generated, the content transmitter 100 transmits encrypted contents, while the content receiver 200 can receive decrypted contents.

When the authentication is successful between the content transmitter 100 and content receiver 200, the content receiver 200 sends a content transmission request to the content transmitter 100, which triggers the transmission of encrypted contents.

Upon completion of the transmission of the required contents, the content transmitter 100 discards the authentication key, exchange key, and common key required for the encryption and decryption of the content. Likewise, the content receiver 200 discards the authentication key, exchange key, and common key, and may start with a new authentication request when it again attempts to receive other contents.

If encrypted data does not arrive at the content receiver due to a loss or a delay of content data on a path during the transmission/reception of the contents, the content receiver 200 virtually transmits the particular content arrival response to the content transmitter 100, as described in the aforementioned first and second embodiments, to abort a retransmission of content data which has not arrived, to solve the problem that a reproduced image is interrupted due to the nonarrival of the content data.

Here, the protocol for use in the transmission of contents from content transmitter 100 to content receiver 200 is not limited to any particular one, but RTP (Real-time Transport Protocol), HTTP (Hyper Text Transfer Protocol), FTP (File Transfer Protocol) and the like can be used.

In regard to the transmission of contents, the contents may be encrypted by a predefined algorithm using the common key, stored in a payload section in each transfer protocol, and transmitted to the content receiver 200. The encryption algorithm suitable for use herein may be, for example, AES (Advanced Encryption Standard) which is a known encryption technique.

### Fourth Embodiment

In a fourth embodiment, contents are transmitted from a content transmitter 700 to a content receiver 800 through a wireless LAN.

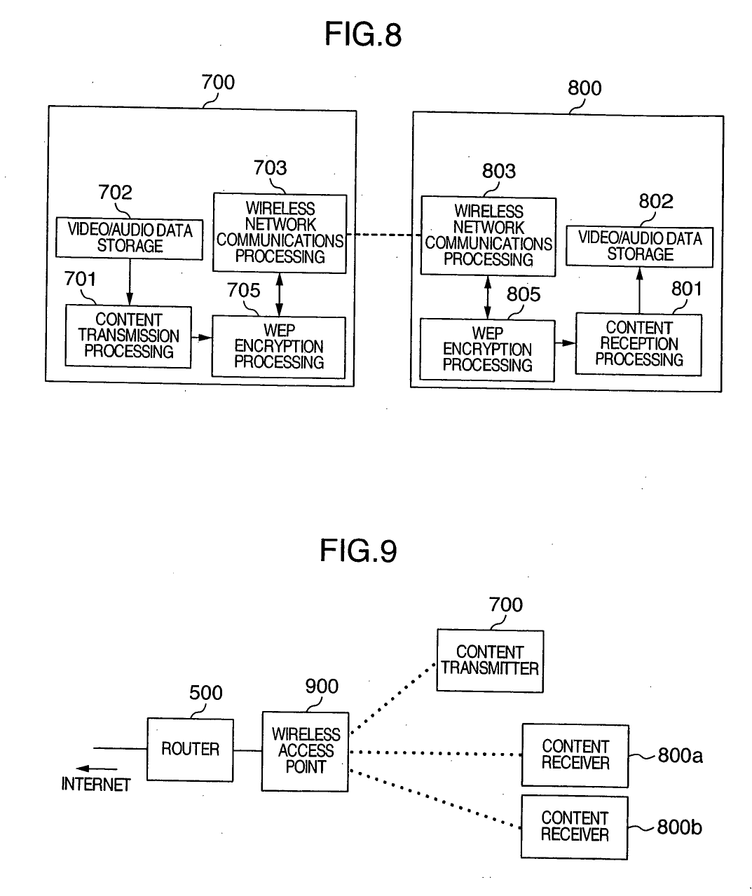

FIG. 8 illustrates a content transmitter and a content receiver which use a wireless LAN, and comprise wireless communications processing units 703, 803, and WEP (Wired Equivalent Privacy) encryption processing circuits 705, 805, respectively.

The WEP is a known encryption method which is commonly used for purpose of security protection in wireless LAN, and can accomplish security protected communications between a transmitter and a receiver under the management of the user.

FIG. 9 illustrates an exemplary configuration of a domestic network which uses the content transmitter 700 and content receiver 800. In FIG. 9, the data transmitter 700 and two data receivers 800a, 800b are connected through a wireless LAN by a wireless access point 900. The wireless access point 900 is further connected to a router 500 which is connected to the Internet, like the router 500 shown in FIG. 2.

For performing the mutual authentication and subsequently transmitting contents between the content transmitter 700 and content receiver 800 shown in FIG. 8, the WEP encryption processing circuits 705, 805 check whether or not the WEP processing has been performed. Then, if the WEP processing has not been performed, the content transmitter 700 and content receiver 800 avoid the mutual authentication and subsequent transmission of the contents, or perform necessary processing such as displaying a message for prompting the user to activate the WEP processing.

In the foregoing manner, when contents are transmitted through a wireless LAN, the WEP processing has been performed without fail.

As a result, the content transmitter 700 can be prevented from being connected to another data receiver through a wireless LAN to make illegal copies of contents, while the users of the content transmitter 700 and content receiver 800 are not conscious, and the problem of an interrupted video signal can be solved in the content receiver in completely the same manner as the content transmission procedure performed by the content transmitter and content receiver described in the first and second embodiments.

In the foregoing embodiments, when content data transmitted from the content transmitter does not arrive at the content receiver, the content receiver transmits the virtual particular content reception confirmation response to the content transmitter, so that the content transmitter aborts a retransmission of the content data and transmits the next content data, thereby making it possible to solve the problem that the image playback processing is temporarily stopped in the content receiver. Also, while the content receiver receives content data which has not arrived, the content receiver may reproduce a video signal at lower speeds to prevent the temporary stop of the image playback processing.

While the foregoing description has been made on the transmission/reception of content data stored in a video/audio storage module of a content transmitter, it should be understood that the foregoing description can be applied to live video/audio data transmitted from satellites or ground-based facilities.

The present invention can provide a content transmitter and a content receiver which can prevent a temporary stop of image playback processing due to nonarrival of content data when contents are transmitted through a wired or a wireless LAN.

It should be further understood by those skilled in the art that although the foregoing description has been made on embodiments of the invention, the invention is not limited thereto and various changes and modifications may be made without departing from the spirit of the invention and the scope of the appended claims.

1. A content receiver comprising:
a network communications processing module for transmitting/receiving data through a network;
a content reception processing module for receiving content data received from a content transmitter connected through the network from said network communications processing module;
a video/audio data storage module for storing video/audio data; and
a processing control module for controlling operation of said network communication processing module, said content reception processing module, and said video/audio data storage module,
wherein said content receiver makes a transmission control protocol connection with said content transmitter, and
said content receiver transmits a particular content data reception confirmation response to said content transmitter, when said content receiver confirms that part of content data delivered from said content transmitter has not arrived at said content receiver, without transmitting a content data nonarrival response to request a retransmission of the content data.

2. A content receiver comprising:
a network communications processing module for transmitting/receiving data through a network;
a content reception processing module for receiving content data received from a content transmitter connected through the network from said network communications processing module;
a video/audio data storage module for storing video/audio data; and
a processing control module for controlling operation of said network communications processing module, said content reception processing module, and said video/audio data storage module,
wherein said content receiver makes a transmission control protocol connection with said content transmitter, and
said content receiver transmits a content data nonarrival response in the transmission control protocol connection when said content receiver confirms that part of content data delivered from said content transmitter has not arrived at said content receiver, and transmits a particular content data reception confirmation response to said content transmitter when the content data has not arrived for a predefined time.

3. The content receiver according to claim 1, wherein:
said content receiver makes a transmission control protocol connection with said content transmitter, and
when said content receiver confirms that part of content data delivered from said content transmitter has not arrived at said content receiver, said content receiver transmits the particular content data reception confirmation request to said content transmitter without transmitting the content data nonarrival response, and transmits a request for a retransmission of the nonarrival content data to said content transmitter.

4. A content receiver comprising:
a network communications processing module for transmitting/receiving data through a network;
a content reception processing module for receiving content data received from a content transmitter connected through the network from said network communications processing module;
a video/audio data storage module for storing video/audio data;
an authentication module for issuing and sending an authentication request to said content transmitter, and determining authentication for an authentication request received from said content transmitter;
a decrypting module for generating key information from information generated based on information resulting from execution of authentication in said authentication module, and decrypting content data received from said content transmitter with the key information; and
a processing control module for controlling operation of said network communications processing module, said content reception processing module, said video/audio data storage module, said authentication module, and said decrypting module,
wherein said content receiver makes a transmission control protocol connection with said content transmitter, and
when said content receiver confirms that part of encrypted content data delivered from said content transmitter has not arrived at said content receiver, said content receiver transmits a particular encrypted content data reception confirmation response to said content transmitter without transmitting an encrypted content data nonarrival response to request a retransmission of the encrypted content data.

5. A content transmitter comprising:
a network communications processing module for transmitting/receiving data through a network;
a content transmission processing module for supplying said network communications processing module with content data to be transmitted to a content receiver connected through the network;
a video/audio data storage module for storing video/audio data; and
a processing control means for controlling operation of said network communications processing module, said content reception processing module, and said video/audio data storage module,
wherein said content transmitter makes a transmission control protocol connection with said content receiver, and
when said content transmitter confirms reception of a particular content data reception confirmation response from said content receiver, said content transmitter does not retransmit the content data.

6. The content transmitter according to claim 5, wherein:
said content transmitter temporarily stores the content data when said content transmitter confirms reception of the particular content data reception confirmation response, and transmits stored content data to said content receiver when said content transmitter receives a request from said content receiver for a retransmission of the content data which has not arrived at said content receiver.

7. A content transmitter comprising:
a network communications processing module for transmitting/receiving data through a network;
a content transmission processing module for supplying said network communications processing module with content data to be transmitted to a content receiver connected through the network;
a video/audio data storage module for storing video/audio data;
an authentication module for receiving an authentication request from said content receiver to determine authentication for the authentication request, and issuing its own authentication request to said content receiver;
a content data encrypting module for generating key information from information generated based on information resulting from execution of authentication in said authentication module, and encrypting content data to be transmitted to said content receiver with the key information; and
a processing control module for controlling operation of said network communications processing module, said content reception processing module, said video/audio data storage module, said authentication module, and said encrypting module,
wherein said content transmitter makes a transmission control protocol connection with said content receiver, and
when said content transmitter confirms reception of a particular content data reception confirmation response, said content transmitter does not retransmit the content data encrypted by said encrypting module.

8. A content receiver comprising:
a network communications processing module for transmitting/receiving data through a network;
a content reception processing module for receiving content data received from a content transmitter connected through the network from said network communications processing module;
a video/audio data storage module for storing video/audio data;
an authentication module for issuing and sending an authentication request to said content transmitter, and determining authentication for an authentication request received from said content transmitter;
a decrypting module for generating key information from information generated based on information resulting from execution of authentication in said authentication module, and decrypting content data received from said content transmitter with the key information; and
a processing control module for controlling operation of said network communication processing module, said content reception processing module, said video/audio data storage module, said authentication module, and said decrypting module,
wherein said content receiver makes a transmission control protocol connection with said content transmitter, and
when said content receiver confirms that part of encrypted content data delivered from said content transmitter has not arrived at said content receiver, said content receiver transmits a particular encrypted content data reception confirmation response to said content transmitter without transmitting a content data nonarrival response to request a retransmission of the encrypted content data, and corrects the content data which has not arrived at said content receiver.

9. A network system comprising:
a content receiver having a network communications processing module for transmitting and receiving data through a network; and
a content transmitter for transmitting content data to said content receiver through the network,
wherein said content receiver makes a transmission control protocol connection with said content transmitter,
when said content receiver confirms that part of content data delivered from said content transmitter has not arrived at said content receiver, said content receiver transmits a particular content data reception confirmation request to said content transmitter without transmitting content data nonarrival response to request said content transmitter to retransmit the content data, and
when said content transmitter confirms reception of the particular content data reception confirmation response from said content receiver, said content transmitter does not retransmit the content data.

10. A content receiving method for execution by a content receiver for receiving content data from a content transmitter connected through a network, said content receiver having a network communications processing module for transmitting/receiving data through the network, said method comprising the steps of:
making a transmission control protocol connection with said content transmitter; and
transmitting a particular content data reception confirmation response to said content transmitter, when said content receiver confirms that part of content data delivered from said content transmitter has not arrived at said content receiver, without transmitting a content data nonarrival response to request said content transmitter for a retransmission of the content data.

11. A content receiving method for execution by a content transmitter for transmitting content data to a content receiver connected through a network, said content transmitter having a network communications processing module for transmitting/receiving data through the network, said method comprising the steps of:
making a transmission control protocol connection with said content receiver;
when said content receiver confirms that part of content data delivered from said content transmitter has not arrived at said content receiver, and transmits a particular content data reception confirmation response to said content transmitter without transmitting a content data nonarrival response to request said content transmitter for a retransmission of the content data, confirming reception of the particular content data reception confirmation response; and
confirming reception of the particular content data reception confirmation response to avoid a retransmission of the content data.
